(19) United States
(12) Patent Application Publication
(10) Pub. No.: US 2015/0367306 A1
(43) Pub. Date: Dec. 24, 2015

(54) Free-Flowing Dispersion Containing Particulate Metal Oxides, Metal Oxide Hydrates and/or Metal Hydroxides, A Dispersant and an Organic Dispersion Medium

(71) Applicant: Sasol Performance Chemicals GmbH, Hamburg (DE)

(72) Inventors: Christian Radloff, Munster (DE); Dirk Niemeyer, Brunsbuttel (DE); Marc Sons, Gelsenkirchen (DE); Oliver Herzog, Brunsbuttel (DE); Renate Behnke, Marl (DE); Thomas Huppe, Gescher (DE); Thomas Sachau, Hochdonn (DE); Ulrike Fischer, Dorsten (DE)

(21) Appl. No.: 14/767,900

(22) PCT Filed: Feb. 19, 2014
(86) PCT No.: PCT/DE2014/000067

§ 371 Date: Aug. 13, 2015

(30) Foreign Application Priority Data
Feb. 20, 2013 (DE) 10 2013 101 701.0

(51) Int. Cl. B01F 17/00

(52) U.S. Cl. CPC B01F 17/0021; B01F 17/0085; B01F 17/0007; B01F 17/0014; B01F 17/0092; B01F 17/0028

(57) ABSTRACT

The subject of the invention is a free-flowing dispersion containing at least one particulate metal oxide, metal oxide hydrate and/or metal hydroxide as a suspended solid, a dispersant and an organic, liquid dispersion medium. The invention also relates to the use of said dispersant.

The invention relates to a free-flowing dispersion containing at least one particulate metal oxide, metal oxide hydrate and/or metal hydroxide as a suspended solid, a dispersant and an organic, liquid dispersion medium. The invention also relates to the use of said dispersant.

Powders are introduced as solids into lacquers, films, coatings and moulding compounds in order to positively influence properties such as tensile strength, compressive strength, abrasion resistance and processability. Furthermore, other characteristics such as coloration, UV protection and magnetic, optical or electrical properties may be imparted to the materials by means of functional fillers. The powders are often introduced in the form of suspensions, i.e. as solids that are dispersed in a liquid medium, in which the former are however insoluble or only very sparingly soluble and do not combine with one another chemically.

If only a liquid dispersion medium and a dispersed solid are present, one speaks of a suspension. In the present case however, reference is made in general to dispersions, i.e. heterogeneous substance mixtures consisting of at least two substances, whereby in the present case at least the dispersion medium is liquid (continuous phase) and at least the dispersed material or the dispersed material mixture is solid (dispersed phase). Other substances may however be additionally present that for example are also gaseous, or the liquid continuous phase contains a liquid as a further dispersed phase in addition to the dispersant and the dispersion medium.

In order to ensure homogenous characteristics of the materials, it is essential that the solids be homogeneously dispersed in the liquid dispersion medium. This is all the more difficult the finer the solids employed and the poorer the tolerance or compatibility between the solid and the liquid dispersion medium. The main factors in this connection are the viscosity and the stability of the resulting mixture. Generally, an increase in viscosity arises through the addition of fine solids.

The viscosity may also increase to an unacceptable degree after dispersion. The present invention has therefore set itself the task of providing liquid dispersions of appropriate viscosity and if desired, a high solids content.

A disadvantage in the use of surface modifiers is the necessary precise knowledge of the surface to be modified. Surface modifiers that are used in excess and do not interact with the surface may result in difficulties in reprocessing of the material. An insufficient amount of surface modifiers generally does not result in dispersion or only to an inadequate extent.

A disadvantage in the use of dispersants is in general the increase in the chemical complexity ultimately caused by the “contamination” of the total mixture. It is desirable that the number of different components in the system should remain as few as possible.

Many publications have appeared that describe dispersions of solids in liquid media wherein either the surface of the solid is modified in order to enhance the dispersing capacity or wetting or dispersing agents are added.

Dispersions of aluminium oxides, including boehmites, in organic solvents using surfactants as dispersants are known for instance from WO 2009/051905 A2. J. Am. Ceram. Soc., 89 [3] 882-887 (2006) describes the surface modification of gamma aluminium powder with oleic acid and subsequent dispersion in non-polar solvents. Colloids and Surfaces, 56 (1991) 25-43 discloses dispersions of alumina in toluene and THF. Linoleic acid or polyisobutylene succinimide were used as dispersants, in the manner of the commercial product OLOA 1200. Linoleic acid yielded a 58 vol. % dispersion and OLOA 1200 a 66 vol. % dispersion.

The purpose of the present invention is therefore to provide a low-viscosity dispersion that is already highly filled at low dispersant concentrations, containing metal oxide, metal oxide hydrate and/or metal hydroxide particles in an organic, liquid dispersion medium, wherein the dispersed particles should not agglomerate or sediment.

It was possible to solve the problem in a surprising way by means of the dispersion according to the invention and the dispersant employed, as described in the independent claims. Preferred embodiments are the subject of the subclaims or are described below. The dispersant is characterised in that metal oxides, metal oxide hydrates, metal hydroxides and mixtures thereof can be dispersed in organic solvents and diluents under mechanical energy input to form liquid dispersions, including those with a high solids content.

The term metal oxide is to be understood such that metalloid oxides are included, but non-metal oxides are excluded. Metalloid oxides are classified with metal oxides. In case of several possible oxide forms of an element from the group of included element, basically all forms and modifications are meant. The same applies to metal oxide hydrates and metal hydroxides. Permutations of the groups are likewise included, i.e. metals comprising oxide, hydrate and/or hydroxide groups.

The metals on which the metal oxides/metal oxide hydrates and metal hydroxides are based are preferably transition metals, rare earths and/or aluminium. Also included in case of several metals are mixed oxides and crystal modifications containing several of the metals, particularly consisting of several of the metals. The same applies to metal oxide hydrates and metal hydroxides.

The mean particle diameter of the dispersed metal oxide, metal oxide hydrate and metal hydroxide particles—as determined by light scattering in the dispersion—is on average less than 200 nm and preferably less than/equal to 100 nm. The particle diameter of between 10 and 100 nm and in particular between 40 and 80 nm is particularly preferred.

A boehmite and/or alumina dispersion preferably possesses a colour index of less than 10 hazen and particularly preferably less than 5 hazen (measured respectively according to DIN EN 1557).

The percentage of metal oxides, metal hydroxides and/or metal oxide hydrates in the dispersion is preferably 1 to 80% by weight, preferably 5 to 70% by weight and particularly preferably 20 to 60% by weight.

The dispersant has the following general formula

R—[AO]_{d}—O—CH₂—COOX
wherein
R represents an aliphatic hydrocarbyl (linear or branched or cyclic) with 6 to 36 carbon atoms, particularly 12 to 24 and particularly preferably 13 to 17,
AO represents 1 to 20 EO, 0 to 20 PO and/or 0 to 5 BO in any sequence with
   EO=—OCH₂CH₂—,
   PO=—OCH₂CH(CH₃)— or OCH(CH₃)CH₂—,
   BO=—OCH₂CH(CH₂CH₃)— or OCH(CH₂CH₃)CH₂—,
X represents hydrogen or a countercation and
d represents respectively on average 3 to 30, in particular 5 to 30 and particularly preferably 4 to 12.

The countercation may be an alkali metal cation or less preferably a (½) alkaline earth metal cation or ammonium or substituted ammonium [NHₙLₘ]⁺ where n=0 to 4 and m=4−n.

The dispersant preferably amounts to a percentage of 1 to 10% by weight of the total weight of the dispersion.

Furthermore, the dispersant may contain potassium chloride, sodium chloride, chloroacetic acid, a residual water content, a residual content of an alcohol R-OH and likewise display a residual content of

R—[AO]_{d}—OH

of for example less than 5% by weight. R, AO and d have meaning given above.

The dispersion according to the invention contains as a further essential component an organic solvent, selected from the group of protic and aprotic solvents.

The organic solvent of the dispersion according to the invention is to be selected in particular from the group of linear and branched aliphatic alcohols, aromatic alcohols, esters, ketones, cyclic ethers, aliphatic ethers and aromatic solvents.

Examples of solvents include saturated aliphatic hydrocarbons such as n-pentane, hexane, n-heptane, isooctane and dodecane; cycloaliphatic hydrocarbons such as cyclopentane and cyclohexane; aromatic hydrocarbons such as benzene, toluene, xylene and mesitylene; cyclic ethers such as tetrahydrofuran (THF) and dioxane, ketones such as methylisobutylketone (MIBK), halogenated alkanes, such as trichloroethane, halogenated aromatic hydrocarbons such as chlorobenzene and bromobenzene, alcohols such as methanol, ethanol, 1-propanol, 2-propanol, 1butanol, 2-butanol, 2-methyl-1-butanol, 1,1-dimethyl-1-ethanol, pentanol, hexanol, cyclohexanol, hepatanol and octanol. Furthermore, the solvents may be used indilo vidually or as a mixture of two or several different solvents.

Preferred are xylene, ethanol (with a water content of less than 50% by weight, particularly less than 10% by weight), isopropanol, (with a water content of less than 50% by weight and particularly less than 10% by weight). Particularly preferred are methoxypropyl acetate (e.g. of a purity of 96% by weight), toluene (e.g. of a purity of >99% by weight) or butyl acetate (e.g. of a purity of >99%).

### EXAMPLES

The solvents toluene (Sigma-Aldrich), butyl acetate (Merck) (BuOAc) and methoxypropyl acetate (MPA) (Merck) were employed without any further pretreatment, as purchased commercially. The boehmites DISPERAL® HP 14 and PURAL® 1000 from SASOL Germany GmbH were used and TiO₂ AppliChem GmbH (purity 98%) was used; Fe₂O₃ was purchased from Riedel-de Haen (purity 95% by weight). Aerosil® R972 and Aerosil® 200V were purchased from Evonik Industries.

### Example 1

### DISPERAL HP 14 in Toluene

10 g of dispersing agent A, a carboxymethylated iso C13 alcohol with an average of 7 ethylene oxide units and 60 g of toluene (purity >99.7%) were transferred to a 150 ml glass beaker (high-sided). The mixture was subsequently homogenised using the sonication finger (Branson Digital Sonifier S-450 D) at an amplitude of 100% and a running time of 30 seconds. 30 g DISPERAL® HP 14 was then successively added to the mixture. The mixture was subsequently dispersed using the sonication finger at an amplitude of 100% and a running time of 60 seconds.

### Example 2

### DISPERAL HP 14 in Butyl Acetate

10 g of dispersing agent A and 60 g of butyl acetate (BuOAc) (purity greater than >99%) were transferred to a 150 ml glass beaker (high-sided). The mixture was subsequently homogenised using the sonication finger (Branson Digital Sonifier S-450 D) at an amplitude of 100% and a running time of 30 seconds. 30 g DISPERAL® HP 14 was then successively added to the mixture. The mixture was subsequently dispersed using the sonication finger at an amplitude of 100% and a running time of 60 seconds.

### Example 3

### DISPERAL HP 14 in Methoxypropyl Acetate

4 g of dispersing agent A (MW 4538) and 81 g of methoxypropyl acetate (purity approx. 96%) were transferred to a 150 ml glass beaker (high-sided). The mixture was subsequently homogenised using the sonication finger (Branson Digital Sonifier S-450 D) at an amplitude of 100% and a running time of 30 seconds. 15 g DISPERAL® HP 14 was then successively added to the mixture. The mixture was subsequently dispersed using the sonication finger at an amplitude of 100% and a running time of 60 seconds.

In the case of the dispersions according to examples 1 to 3, no sedimentation was detectable even after 6 months and the dispersions appeared visually unchanged.

A similar procedure was adopted for the examples apparent from Table 1.

TABLE 1

| | | Dis- | | Dis- | | |
|---|---|---|---|---|---|---|
| | | persing | | persing | | Metal |
| | Dis- | agent | | medium | | oxide |
| | persing | [% by | | [% by | Metal | [% by |
| No. | agent | weight] | Di | weight] | oxide | weight] |
| 4 | B | 5 | BuOAc | 80 | DISPERAL ® | 15 |
| | | | | | HP 14 | |
| 5 | C | 5 | BuOAc | 80 | DISPERAL ® | 15 |
| | | | | | HP 14 | |
| 6 | D | 5 | BuOAc | 80 | DISPERAL ® | 15 |
| | | | | | HP 14 | |
| 7 | E | 5 | BuOAc | 80 | DISPERAL ® | 15 |
| | | | | | HP 14 | |
| 8 | A | 5 | BuOAc | 94 | TiO₂ | 1 |
| 9 | A | 5 | BuOAc | 94 | Fe₂O₃ | 1 |
| 10 | A | 5.35 | Xylene | 35.72 | PURAL ® | 58.93 |
| | | | | | 1000 | |
| 11 | A | 1 | Ethanol | 89 | Aerosil ® | 10 |
| | | | | | 200V | |
| 12 | A | 1 | Ethanol | 89 | Aerosil ® | 10 |
| | | | | | R972 | |
| 13 | A | 2 | MPA | 93 | Aerosil ® | 5 |
| | | | | | 200V | |

B is a carboxymethylated C9 alcohol with initially an average of 2.4 propylene oxide units and subsequently an average of 1.6 ethylene oxide units.
C is a carboxymethylated C16/C18/C20 Guerbet alcohol with an average of 7 ethylene oxide units.
D is a carboxymethylated C16/C18 alcohol with initially an average of 6 propylene oxide units and subsequently an average of 6 ethylene oxide units.
E is a carboxymethylated C16/C18 alcohol with initially an average of 4.5 propylene oxide units and subsequently an average of 2 ethylene oxide units.
DISPERAL ® HP 14 and PURAL ® 1000 are boehmites and commercial products from Sasol Germany GmbH. DISPERAL ® and PURAL ® are respectively protected brand names of Sasol Germany GmbH.

1. Free-flowing dispersion comprising
at least one particulate metal oxide, metal oxide hydrate, metal hydroxide or mixtures thereof as a suspended solid,
at least one organic, liquid dispersion medium and
at least one dispersant, wherein the dispersant has the following general formula:
R—[AO]_{d}—O—CH₂—COOX
wherein
R represents an aliphatic hydrocarbyl with 6 to 36 carbon atoms,
AO represents 1 to 20 EO, 0 to 20 PO and/or 0 to 5 BO in any sequence with
EO=—OCH₂CH₂—,
PO=—OCH₂CH(CH₃)— or —OCH(CH₃)CH₂—,
BO=—OCH₂CH(CH₂CH₃)— or —OCH(CH₂CH₃)CH₂—,
X represents hydrogen or a countercation and
d represents on average 3 to 30.

2. Dispersions according to claim 1, wherein
AO a) represents on average 5 to 12 EO or
b) represents on average 1 to 3 PO and 7 to 14 EO.

3. Dispersion according to claim 1, wherein the aliphatic hydrocarbyl R has 12 to 24 carbon atoms and also independently thereof is an alkyl radical.

4. Dispersions according to claim 1, wherein the organic, liquid dispersion medium is selected from among toluene, butyl acetate, methoxypropyl acetate, xylene, isopropanol with a water content of less than 50% by weight, ethanol with a water content of less than 50% by weight and mixtures thereof.

5. Dispersion according to claim 1, characterised in that the metal oxides, metal hydroxides or metal oxide hydrates are the oxides, hydroxides or oxide hydrates of aluminium, iron, titanium, silicon, copper or mixtures thereof, including the mixed oxides of aluminium and silicon.

6. Dispersion according claim 1, characterised in that the metal oxides, metal hydroxides or metal oxide hydrates involve alumina and/or boehmite.

7. Dispersion according to claim 1, wherein the dispersion has a colour index according to DIN EN1557 of less than 10 hazen.

8. Dispersion according to claim 1, wherein the dispersion remains stable for at least 6 months without sedimenting.

9. Dispersion according to claim 1, wherein the percentage of metal oxides, metal hydroxides or metal oxide hydrates is 1 to 80% by weight, preferably 5 to 70% by weight and particularly preferably 20 to 60% by weight.

10. Dispersion according to claim 1, wherein the percentage of metal oxides, metal hydroxides or metal oxide hydrates in the dispersion is at least 20% by weight.

11. Dispersion according to claim 1, wherein the percentage of the dispersant in the dispersion is 0.5 to 20% by weight.

12. Dispersion according to claim 1, wherein the percentage of the dispersing medium is at least 19.5% by weight.

13. Dispersion according to claim 1, wherein the mean particle diameter of the metal oxides, metal oxide hydrates and metal hydroxides in the dispersion determined by light scattering is less than 200 nm.

14. (canceled)

15. Method of making a free-flowing dispersion comprising:
providing at least one particulate metal oxide, metal oxide hydrate, metal hydroxide or mixtures thereof as a suspended solid,
providing at least one organic, liquid dispersion medium and
providing at least one dispersant, wherein the dispersant has the following general formula:
R—[AO]_{d}—O—CH₂—COOX
wherein
R represents an aliphatic hydrocarbyl with 6 to 36 carbon atoms,
AO represents 1 to 20 EO, 0 to 20 PO and/or 0 to 5 BO in any sequence with
EO=—OCH₂CH₂—,
PO=—OCH₂CH(CH₃)— or —OCH(CH₃)CH₂—,
BO=—OCH₂CH(CH₂CH₃)— or —OCH(CH₂CH₃)CH₂—,
X represents hydrogen or a countercation and
d represents on average 3 to 30.
